(19) United States
(12) Patent Application Publication
(10) Pub. No.: US 2023/0281839 A1
(43) Pub. Date: Sep. 7, 2023

(54) IMAGE ALIGNMENT WITH SELECTIVE LOCAL REFINEMENT RESOLUTION

(71) Applicant: INNOPEAK TECHNOLOGY, INC., Palo Alto, CA (US)

(72) Inventors: Kim C. NG, Palo Alto, CA (US); Jinglin SHEN, Palo Alto, CA (US); Chiuman HO, Palo Alto, CA (US)

(21) Appl. No.: 18/315,295

(22) Filed: May 10, 2023

Related U.S. Application Data
(63) Continuation of application No. PCT/US2021/027415, filed on Apr. 15, 2021.
(60) Provisional application No. 63/113,145, filed on Nov. 12, 2020.

(51) Int. Cl. G06T 7/33; G06T 7/10; G06T 7/37; G06T 7/55; G06T 5/50

(52) U.S. Cl. CPC G06T 7/337; G06T 7/10; G06T 7/37; G06T 7/55; G06T 5/50; G06T 2207/20021; G06T 2207/10024; G06T 2207/10048; G06T 2207/20221; G06T 2207/20081; G06T 2207/20084

(57) ABSTRACT

This application is directed to image registration. A computer system aligns two images of a scene globally to generate a third image and a fourth image that correspond to the two images and are aligned with each other. The computer system divides each of the third and fourth images to multiple grid cells including a respective first grid cell. The respective first grid cells of the third and fourth images are aligned with each other. For the respective first grid cells, the computer system identifies one or more first feature points, divides each respective first grid cell to a set of sub-cells and updating the first feature points in accordance with a determination that a grid ghosting level is greater than a grid ghosting threshold, and aligns the third and fourth images based on the updated first feature points of the respective first grid cells.

### RELATED APPLICATIONS

This application is a continuation of International Application No. PCT/US2021/027415, filed Apr. 14, 2021, which claims priority to U.S. Provisional Patent Application No. 63/113,145, filed Nov. 12, 2020, the entire disclosures of which are incorporated herein by reference.

### TECHNICAL FIELD

The present disclosure generally relates to the field of image processing, particularly to, an image registration method, a computer system, and a non-transitory computer-readable medium.

### BACKGROUND

Image fusion techniques are applied to combine information from different image sources into a single image. Resulting images contain more information than that provided by any single image source. The different image sources often correspond to different sensory modalities located in a scene to provide different types of information (e.g., colors, brightness, and details) for image fusion. For example, color images are fused with near-infrared (NIR) images, which enhance details in the color images while substantially preserving color and brightness information of the color images. Particularly, NIR light can travel through fog, smog, or haze better than visible light, allowing some dehazing algorithms to be established based on a combination of the NIR and color images. However, color in resulting images that are fused from the color and NIR images can deviate from true color of the original color images. It would be beneficial to have a mechanism to implement image fusion effectively and improve quality of images resulting from image fusion.

### SUMMARY

In one aspect, an image registration method is provided, including: obtaining a first image and a second image of a scene; aligning the first and second images globally to generate a third image corresponding to the first image and a fourth image corresponding to the second image and aligned with the third image; dividing each of the third image and the fourth image to a respective plurality of grid cells including a respective first grid cell, where the respective first grid cells of the third and fourth images are aligned with each other; for the respective first grid cell of each of the third and fourth images: identifying one or more first feature points; and in accordance with a determination that a grid ghosting level of the respective first grid cell is greater than a grid ghosting threshold, dividing the respective first grid cell to a set of sub-cells and updating the one or more first feature points in the set of sub-cells; and aligning the third and fourth images based on the one or more updated first feature points of the respective first grid cell of each of the third and fourth images.

According to another aspect of the present disclosure, a computer system is provided, which includes: one or more processors; and memory having instructions stored thereon, which when executed by the one or more processors cause the processors to perform an image registration method, including: obtaining a first image and a second image of a scene; aligning the first and second images globally to generate a third image corresponding to the first image and a fourth image corresponding to the second image and aligned with the third image; dividing each of the third image and the fourth image to a respective plurality of grid cells including a respective first grid cell, where the respective first grid cells of the third and fourth images are aligned with each other; for the respective first grid cell of each of the third and fourth images: identifying one or more first feature points; and in accordance with a determination that a grid ghosting level of the respective first grid cell is greater than a grid ghosting threshold, dividing the respective first grid cell to a set of sub-cells and updating the one or more first feature points in the set of sub-cells; and aligning the third and fourth images based on the one or more updated first feature points of the respective first grid cell of each of the third and fourth images.

According to another aspect of the present disclosure, it is provided a non-transitory computer readable storage medium having instructions stored thereon, which when executed by one or more processors cause the processors to perform the image registration method described above.

### BRIEF DESCRIPTION OF THE DRAWINGS

The accompanying drawings, which are included to provide a further understanding of the embodiments and are incorporated herein and constitute a part of the specification, illustrate the described embodiments and together with the description serve to explain the underlying principles.

FIG. 1 is an example data processing environment having one or more servers communicatively coupled to one or more client devices, in accordance with some embodiments.

FIG. 2 is a block diagram illustrating a data processing system, in accordance with some embodiments.

FIG. 3 is an example data processing environment for training and applying a neural network based (NN-based) data processing model for processing visual and/or audio data, in accordance with some embodiments.

FIG. 4A is an example neural network applied to process content data in an NN-based data processing model, in accordance with some embodiments, and FIG. 4B is an example node in the neural network, in accordance with some embodiments.

FIG. 5 is an example framework of fusing an RGB image and an NIR image, in accordance with some embodiments.

FIG. 6A is an example framework of implementing an image registration process, in accordance with some embodiments, and FIGS. 6B and 6C are two images that are aligned during the image registration process, in accordance with some embodiments.

FIGS. 7A-7C are an example RGB image, an example NIR image, and an improperly registered image of the images in accordance with some embodiments, respectively.

FIGS. 8A and 8B are an overlaid image and a fused image, in accordance with some embodiments, respectively.

FIG. 9 is a flow diagram of an image fusion method implemented at a computer system, in accordance with some embodiments.

FIG. 10 is a flow diagram of an image registration method implemented at a computer system, in accordance with some embodiments.

Like reference numerals refer to corresponding parts throughout the several views of the drawings.

### DETAILED DESCRIPTION OF EMBODIMENTS

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

The present disclosure is directed to combining information of a plurality of images by different mechanisms and applying additional pre-processing and post-processing to improve an image quality of a resulting fused image. In some embodiments, an RGB image and an NIR image can be decomposed into detail portions and base portions and are fused in a radiance domain using different weights. In some embodiments, radiances of the RGB and NIR images may have different dynamic ranges and can be normalized via a radiance mapping function. For image fusion, in some embodiments, luminance components of the RGB and NIR images may be combined based on an infrared emission strength, and further fused with color components of the RGB image. In some embodiments, a fused image can also be adjusted with reference to one of a plurality of color channels of the fused image. In some embodiments, a base component of the RGB image and a detail component of the fused image are extracted and combined to improve the quality of image fusion. Prior to any fusion process, the RGB and NIR images can be aligned locally and iteratively using an image registration operation. Further, when one or more hazy zones are detected in an input RGB image or a fused image, white balance is adjusted locally by saturating a predefined portion of each hazy zone to suppress a hazy effect in the RGB or fused image. By these means, the image fusion can be implemented effectively, thereby providing images with better image qualities (e.g., having more details, better color fidelity, and/or a lower hazy level).

The present disclosure relates to an image registration method, including: obtaining a first image and a second image of a scene; aligning the first and second images globally to generate a third image corresponding to the first image and a fourth image corresponding to the second image and aligned with the third image; dividing each of the third image and the fourth image to a respective plurality of grid cells including a respective first grid cell, where the respective first grid cells of the third and fourth images are aligned with each other; for the respective first grid cell of each of the third and fourth images: identifying one or more first feature points; and in accordance with a determination that a grid ghosting level of the respective first grid cell is greater than a grid ghosting threshold, dividing the respective first grid cell to a set of sub-cells and updating the one or more first feature points in the set of sub-cells; and aligning the third and fourth images based on the one or more updated first feature points of the respective first grid cell of each of the third and fourth images.

In at least one embodiment, the method further includes: for a respective second grid cell of each of the third and fourth images, the respective second grid cell being distinct from the respective first grid cell: identifying one or more second feature points; and determining that a grid ghosting level of the respective second grid cell is less than the grid ghosting threshold, where the third and fourth images are further aligned based on the one or more second feature points of the respective second grid cell of each of the third and fourth images.

In at least one embodiment, the plurality of grid cells include remaining grid cells distinct from the respective first grid cell for each of the third and fourth images, the method further including scanning a subset of the remaining grid cells by: for each of the subset of remaining grid cells in the third and fourth images: identifying one or more remaining feature points; and in accordance with a determination that a grid ghosting level of the respective remaining grid cell is greater than the grid ghosting threshold, iteratively dividing the respective remaining grid cell to a set of remaining sub-cells and updating the one or more remaining feature points in the set of remaining sub-cells, until a sub-cell ghosting level of each remaining sub-cell is less than a respective sub-cell ghosting threshold.

In at least one embodiment, the first and second images are aligned globally based on a transformation function, and aligning the third and fourth images further includes: updating the transformation function based on the one or more updated first feature points of the respective first grid cell of each of the third and fourth images, the third and fourth images are further aligned based on the updated transformation function.

In at least one embodiment, the one or more updated first feature points include a subset of the one or more first feature points, one or more additional feature points in the set of the sub-cells, or a combination thereof, and each of the one or more additional feature points is distinct from any of the one or more first feature points.

In at least one embodiment, the method further includes: determining the grid ghosting level of the respective first grid cell of each of the third and fourth images based on the one or more first feature points; and comparing the grid ghosting level of the first grid cell with the grid ghosting threshold.

In at least one embodiment, aligning the first and second images globally further includes: identifying one or more global feature points each of which is included in both the first and second images; and transforming at least one of the first and second images to align the one or more global feature points in the first and second images.

In at least one embodiment, the third image is identical to the first image and is applied as a reference image, and aligning the first and second images globally includes transforming the second image to the fourth image with reference to the first image.

In at least one embodiment, the method further includes: determining a range of an image depth for the first and second images; and determining whether the range of the image depth exceeds a threshold range, where each of the third and fourth images is divided to the plurality of grid cells in accordance with a determination that the range of the image depth exceeds the threshold range.

In at least one embodiment, the method is implemented by an electronic device having a first image sensor and a second image sensor, and the first and second image sensors are configured to capture the first and second images of the scene in a synchronous manner.

In at least one embodiment, the first image includes an RGB image, the second image includes a near infrared (NIR) image.

In at least one embodiment, the method further includes: converting the re-aligned first image and the re-aligned second image to a radiance domain; decomposing the converted first image to a first base portion and a first detail portion, and decomposing the converted second image to a second base portion and a second detail portion; generating a weighted combination of the first base portion, second base portion, first detail portion and second detail portion using a set of weights; and converting the weighted combination in the radiance domain to a first fused image in an image domain.

In at least one embodiment, the method further includes: matching radiances of the re-aligned first and second images; combining the radiances of the re-aligned first and second images to generate a fused radiance image; and converting the fused radiance image to a second fused image in an image domain.

In at least one embodiment, the method further includes: extracting a first luminance component and a first color component from the re-aligned first image; extracting a second luminance component from the re-aligned second image; determining an infrared emission strength based on the first and second luminance components; combining the first and second luminance components based on the infrared emission strength to obtain a combined luminance component; and combining the combined luminance component with the first color component to obtain a third fused image.

The present disclosure relates to a computer system, including: one or more processors; and memory having instructions stored thereon, which when executed by the one or more processors cause the processors to perform an image registration method, including: obtaining a first image and a second image of a scene; aligning the first and second images globally to generate a third image corresponding to the first image and a fourth image corresponding to the second image and aligned with the third image; dividing each of the third image and the fourth image to a respective plurality of grid cells including a respective first grid cell, where the respective first grid cells of the third and fourth images are aligned with each other; for the respective first grid cell of each of the third and fourth images: identifying one or more first feature points; and in accordance with a determination that a grid ghosting level of the respective first grid cell is greater than a grid ghosting threshold, dividing the respective first grid cell to a set of sub-cells and updating the one or more first feature points in the set of sub-cells; and aligning the third and fourth images based on the one or more updated first feature points of the respective first grid cell of each of the third and fourth images.

In at least one embodiment, the method further includes for a respective second grid cell of each of the third and fourth images, the respective second grid cell being distinct from the respective first grid cell: identifying one or more second feature points; and determining that a grid ghosting level of the respective second grid cell is less than the grid ghosting threshold, where the third and fourth images are further aligned based on the one or more second feature points of the respective second grid cell of each of the third and fourth images.

In at least one embodiment, the plurality of grid cells include remaining grid cells distinct from the respective first grid cell for each of the third and fourth images, and the method further includes scanning a subset of the remaining grid cells by: for each of the subset of remaining grid cells in the third and fourth images: identifying one or more remaining feature points; and in accordance with a determination that a grid ghosting level of the respective remaining grid cell is greater than the grid ghosting threshold, iteratively dividing the respective remaining grid cell to a set of remaining sub-cells and updating the one or more remaining feature points in the set of remaining sub-cells, until a sub-cell ghosting level of each remaining sub-cell is less than a respective sub-cell ghosting threshold.

In at least one embodiment, the first and second images are aligned globally based on a transformation function, and aligning the third and fourth images further includes: updating the transformation function based on the one or more updated first feature points of the respective first grid cell of each of the third and fourth images, the third and fourth images are further aligned based on the updated transformation function.

In at least one embodiment, the method further includes: converting the re-aligned first image and the re-aligned second image to a radiance domain; decomposing the converted first image to a first base portion and a first detail portion, and decomposing the converted second image to a second base portion and a second detail portion; generating a weighted combination of the first base portion, second base portion, first detail portion and second detail portion using a set of weights; and converting the weighted combination in the radiance domain to a first fused image in an image domain.

The present disclosure relates to a non-transitory computer-readable medium, having instructions stored thereon, which when executed by one or more processors cause the processors to perform the image registration method described above.

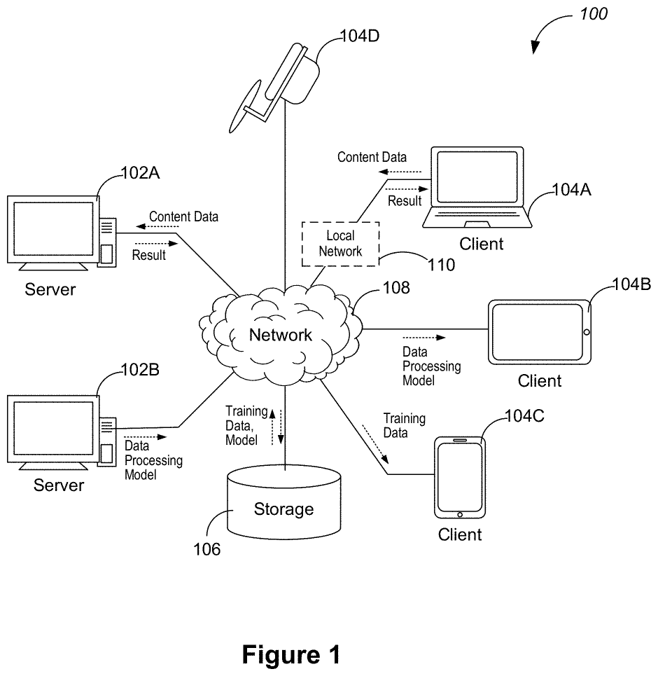

FIG. 1 is an example data processing environment 100 having one or more servers 102 communicatively coupled to one or more client devices 104, in accordance with some embodiments. The one or more client devices 104 may be, for example, desktop computers 104A, tablet computers 104B, mobile phones 104C, or intelligent, multi-sensing, network-connected home devices (e.g., a surveillance camera 104D). Each client device 104 can collect data or user inputs, executes user applications, or present outputs on its user interface. The collected data or user inputs can be processed locally at the client device 104 and/or remotely by the server(s) 102. The one or more servers 102 provides system data (e.g., boot files, operating system images, and user applications) to the client devices 104, and in some embodiments, processes the data and user inputs received from the client device(s) 104 when the user applications are executed on the client devices 104. In some embodiments, the data processing environment 100 further includes a storage 106 for storing data related to the servers 102, client devices 104, and applications executed on the client devices 104.

The one or more servers 102 can enable real-time data communication with the client devices 104 that are remote from each other or from the one or more servers 102. In some embodiments, the one or more servers 102 can implement data processing tasks that cannot be or are preferably not completed locally by the client devices 104. For example, the client devices 104 include a game console that executes an interactive online gaming application. The game console receives a user instruction and sends it to a game server 102 with user data. The game server 102 generates a stream of video data based on the user instruction and user data and providing the stream of video data for concurrent display on the game console and other client devices 104 that are engaged in the same game session with the game console. In another example, the client devices 104 include a mobile phone 104C and a networked surveillance camera 104D. The camera 104D collects video data and streams the video data to a surveillance camera server 102 in real time. While the video data is optionally pre-processed on the camera 104D, the surveillance camera server 102 processes the video data to identify motion or audio events in the video data and share information of these events with the mobile phone 104C, thereby allowing a user of the mobile phone 104C to monitor the events occurring near the networked surveillance camera 104D in real time and remotely.

The one or more servers 102, one or more client devices 104, and storage 106 are communicatively coupled to each other via one or more communication networks 108, which are the medium used to provide communications links between these devices and computers connected together within the data processing environment 100. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 108 may be established either directly (e.g., using 3G/4G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, deep learning techniques are applied in the data processing environment 100 to process content data (e.g., video, image, audio, or textual data) obtained by an application executed at a client device 104 to identify information contained in the content data, match the content data with other data, categorize the content data, or synthesize related content data. In these deep learning techniques, data processing models are created based on one or more neural networks to process the content data. These data processing models are trained with training data before they are applied to process the content data. In some embodiments, both model training and data processing are implemented locally at each individual client device 104 (e.g., the client device 104C). The client device 104C obtains the training data from the one or more servers 102 or storage 106 and applies the training data to train the data processing models. Subsequently to model training, the client device 104C obtains the content data (e.g., captures video data via an internal camera) and processes the content data using the training data processing models locally. Alternatively, in some embodiments, both model training and data processing are implemented remotely at a server 102 (e.g., the server 102A) associated with one or more client devices 104 (e.g. the client devices 104A and 104D). The server 102A obtains the training data from itself, another server 102 or the storage 106 and applies the training data to train the data processing models. The client device 104A or 104D obtains the content data and sends the content data to the server 102A (e.g., in a user application) for data processing using the trained data processing models. The same client device or a distinct client device 104A receives data processing results from the server 102A, and presents the results on a user interface (e.g., associated with the user application). The client device 104A or 104D itself implements no or little data processing on the content data prior to sending them to the server 102A. Additionally, in some embodiments, data processing is implemented locally at a client device 104 (e.g., the client device 104B), while model training is implemented remotely at a server 102 (e.g., the server 102B) associated with the client device 104B. The server 102B obtains the training data from itself, another server 102 or the storage 106 and applies the training data to train the data processing models. The trained data processing models are optionally stored in the server 102B or storage 106. The client device 104B imports the trained data processing models from the server 102B or storage 106, processes the content data using the data processing models, and generates data processing results to be presented on a user interface locally.

In various embodiments of this application, distinct images are captured by a camera (e.g., a standalone surveillance camera 104D or an integrated camera of a client device 104A), and processed in the same camera, the client device 104A containing the camera, a server 102, or a distinct client device 104. Optionally, deep learning techniques are trained or applied for the purposes of processing the images. In an example, a near infrared (NIR) image and an RGB image are captured by the camera 104D or the camera of the client device 104A. After obtaining the NIR and RGB image, the same camera 104D, client device 104A containing the camera, server 102, distinct client device 104 or a combination of them normalizes the NIR and RGB images, converts the images to a radiance domain, decomposes the images to different portions, combines the decomposed portions, tunes color of a fused image, and/or dehazes the fused image, optionally using a deep learning technique. The fused image can be reviewed on the client device 104A containing the camera or the distinct client device 104.

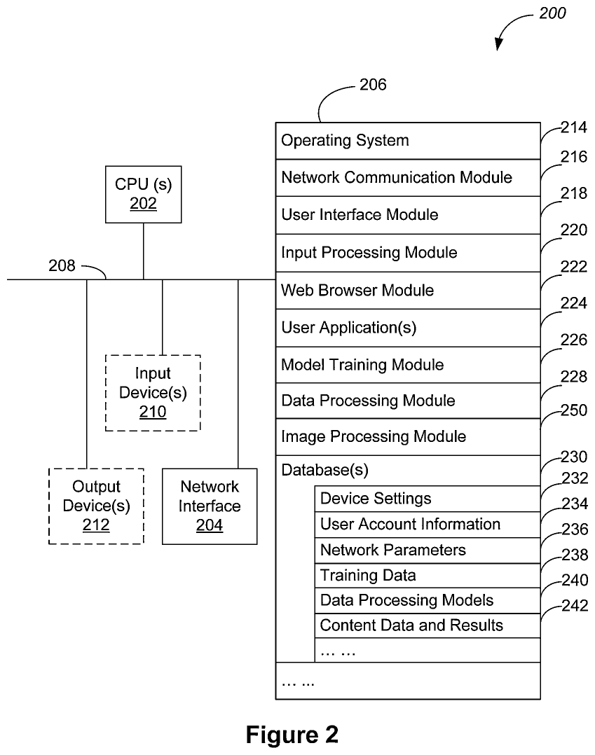

FIG. 2 is a block diagram illustrating a data processing system 200, in accordance with some embodiments. The data processing system 200 includes a server 102, a client device 104, a storage 106, or a combination thereof. The data processing system 200, typically, includes one or more processing units (CPUs) 202, one or more network interfaces 204, memory 206, and one or more communication buses 208 for interconnecting these components (sometimes called a chipset). The data processing system 200 includes one or more input devices 210 that facilitate user input, such as a keyboard, a mouse, a voice-command input unit or microphone, a touch screen display, a touch-sensitive input pad, a gesture capturing camera, or other input buttons or controls. Furthermore, in some embodiments, the client device 104 of the data processing system 200 uses a microphone and voice recognition or a camera and gesture recognition to supplement or replace the keyboard. In some embodiments, the client device 104 includes one or more cameras, scanners, or photo sensor units for capturing images, for example, of graphic serial codes printed on the electronic devices. The data processing system 200 also includes one or more output devices 212 that enable presentation of user interfaces and display content, including one or more speakers and/or one or more visual displays. Optionally, the client device 104 includes a location detection device, such as a GPS (global positioning satellite) or other geo-location receiver, for determining the location of the client device 104.

Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 202. Memory 206, or alternatively the non-volatile memory within memory 206, includes a non-transitory computer readable storage medium. In some embodiments, memory 206, or the non-transitory computer readable storage medium of memory 206, stores the following programs, modules, and data structures, or a subset or superset thereof:
Operating system 214 including procedures for handling various basic system services and for performing hardware dependent tasks;
Network communication module 216 for connecting each server 102 or client device 104 to other devices (e.g., server 102, client device 104, or storage 106) via one or more network interfaces 204 (wired or wireless) and one or more communication networks 108, such as the Internet, other wide area networks, local area networks, metropolitan area networks, and so on;
User interface module 218 for enabling presentation of information (e.g., a graphical user interface for application(s) 224, widgets, websites and web pages thereof, and/or games, audio and/or video content, text, etc.) at each client device 104 via one or more output devices 212 (e.g., displays, speakers, etc.);
Input processing module 220 for detecting one or more user inputs or interactions from one of the one or more input devices 210 and interpreting the detected input or interaction;
Web browser module 222 for navigating, requesting (e.g., via HTTP), and displaying websites and web pages thereof, including a web interface for logging into a user account associated with a client device 104 or another electronic device, controlling the client or electronic device if associated with the user account, and editing and reviewing settings and data that are associated with the user account;
One or more user applications 224 for execution by the data processing system 200 (e.g., games, social network applications, smart home applications, and/or other web or non-web based applications for controlling another electronic device and reviewing data captured by such devices);
Model training module 226 for receiving training data and establishing a data processing model for processing content data (e.g., video, image, audio, or textual data) to be collected or obtained by a client device 104;
Data processing module 228 for processing content data using data processing models 240, thereby identifying information contained in the content data, matching the content data with other data, categorizing the content data, enhancing the content data, or synthesizing related content data, where in some embodiments, the data processing module 228 is associated with one of the user applications 224 to process the content data in response to a user instruction received from the user application 224;
Image processing module 250 for normalizing an NIR image and an RGB image, converting the images to a radiance domain, decomposing the images to different portions, combining the decomposed portions, and/or tuning a fused image, where in some embodiments, one or more image processing operations involve deep learning techniques and are implemented jointly with the model training module 226 or data processing module 228; and
One or more databases 230 for storing at least data including one or more of:
   Device settings 232 including common device settings (e.g., service tier, device model, storage capacity, processing capabilities, communication capabilities, Camera Response Functions (CRFs), etc.) of the one or more servers 102 or client devices 104;
   User account information 234 for the one or more user applications 224, e.g., user names, security questions, account history data, user preferences, and predefined account settings;
   Network parameters 236 for the one or more communication networks 108, e.g., IP address, subnet mask, default gateway, DNS server and host name;
   Training data 238 for training one or more data processing models 240;
   Data processing model(s) 240 for processing content data (e.g., video, image, audio, or textual data) using deep learning techniques; and
   Content data and results 242 that are obtained by and outputted to the client device 104 of the data processing system 200, respectively, where the content data is processed locally at a client device 104 or remotely at a server 102 or a distinct client device 104 to provide the associated results 242 to be presented on the same or distinct client device 104, and examples of the content data and results 242 include RGB images, NIR images, fused images, and related data (e.g., depth images, infrared emission strengths, feature points of the RGB and NIR images, fusion weights, and a predefined percentage and a low-end pixel value end set for localized auto white balance adjustment, etc.).

Optionally, the one or more databases 100 are stored in one of the server 102, client device 104, and storage 106 of the data processing system 200. Optionally, the one or more databases 100 are distributed in more than one of the server 102, client device 104, and storage 106 of the data processing system 200. In some embodiments, more than one copy of the above data is stored at distinct devices, e.g., two copies of the data processing models 240 are stored at the server 102 and storage 106, respectively.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 206, optionally, stores a subset of the modules and data structures identified above. Furthermore, memory 206, optionally, stores additional modules and data structures not described above.

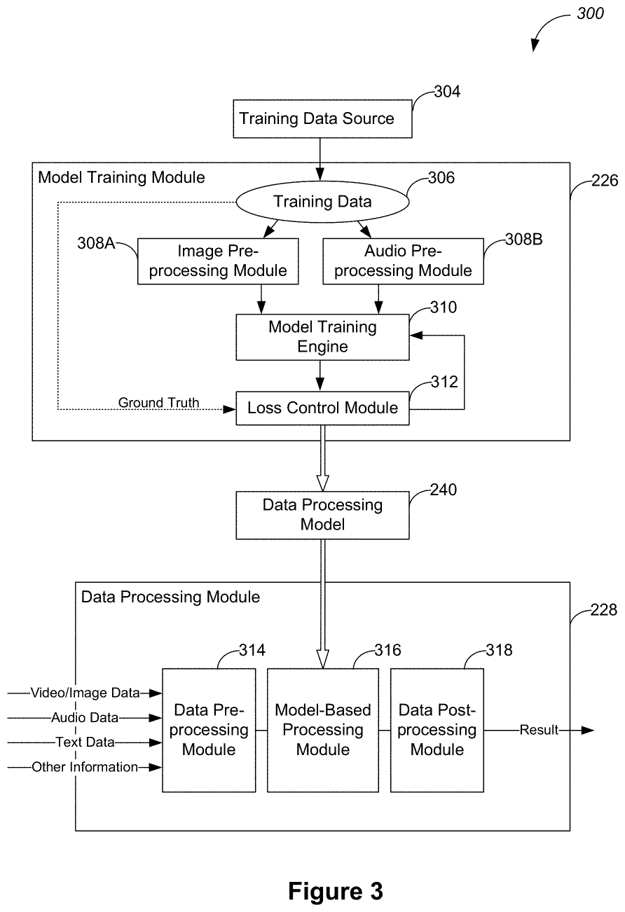

FIG. 3 is another example data processing system 300 for training and applying a neural network based (NN-based) data processing model 240 for processing content data (e.g., video, image, audio, or textual data), in accordance with some embodiments. The data processing system 300 includes a model training module 226 for establishing the data processing model 240 and a data processing module 228 for processing the content data using the data processing model 240. In some embodiments, both of the model training module 226 and the data processing module 228 are located on a client device 104 of the data processing system 300, while a training data source 304 distinct form the client device 104 provides training data 306 to the client device 104. The training data source 304 is optionally a server 102 or storage 106. Alternatively, in some embodiments, both of the model training module 226 and the data processing module 228 are located on a server 102 of the data processing system 300. The training data source 304 providing the training data 306 is optionally the server 102 itself, another server 102, or the storage 106. Additionally, in some embodiments, the model training module 226 and the data processing module 228 are separately located on a server 102 and client device 104, and the server 102 provides the trained data processing model 240 to the client device 104.

The model training module 226 includes one or more data pre-processing modules 308, a model training engine 310, and a loss control module 312. The data processing model 240 is trained according to a type of the content data to be processed. The training data 306 is consistent with the type of the content data, so is a data pre-processing module 308 applied to process the training data 306 consistent with the type of the content data. For example, an image pre-processing module 308A is configured to process image training data 306 to a predefined image format, e.g., extract a region of interest (ROI) in each training image, and crop each training image to a predefined image size. Alternatively, an audio pre-processing module 308B is configured to process audio training data 306 to a predefined audio format, e.g., converting each training sequence to a frequency domain using a Fourier transform. The model training engine 310 receives pre-processed training data provided by the data pre-processing modules 308, further processes the pre-processed training data using an existing data processing model 240, and generates an output from each training data item. During this course, the loss control module 312 can monitor a loss function comparing the output associated with the respective training data item and a ground truth of the respective training data item. The model training engine 310 modifies the data processing model 240 to reduce the loss function, until the loss function satisfies a loss criteria (e.g., a comparison result of the loss function is minimized or reduced below a loss threshold). The modified data processing model 240 is provided to the data processing module 228 to process the content data.

In some embodiments, the model training module 226 offers supervised learning in which the training data is entirely labelled and includes a desired output for each training data item (also called the ground truth in some situations). Conversely, in some embodiments, the model training module 226 offers unsupervised learning in which the training data are not labelled. The model training module 226 is configured to identify previously undetected patterns in the training data without pre-existing labels and with no or little human supervision. Additionally, in some embodiments, the model training module 226 offers partially supervised learning in which the training data are partially labelled.

The data processing module 228 includes a data pre-processing modules 314, a model-based processing module 316, and a data post-processing module 318. The data pre-processing modules 314 pre-processes the content data based on the type of the content data. Functions of the data pre-processing modules 314 are consistent with those of the pre-processing modules 308 and covert the content data to a predefined content format that is acceptable by inputs of the model-based processing module 316. Examples of the content data include one or more of: video, image, audio, textual, and other types of data. For example, each image is pre-processed to extract an ROI or cropped to a predefined image size, and an audio clip is pre-processed to convert to a frequency domain using a Fourier transform. In some situations, the content data includes two or more types, e.g., video data and textual data. The model-based processing module 316 applies the trained data processing model 240 provided by the model training module 226 to process the pre-processed content data. The model-based processing module 316 can also monitor an error indicator to determine whether the content data has been properly processed in the data processing model 240. In some embodiments, the processed content data is further processed by the data post-processing module 318 to present the processed content data in a preferred format or to provide other related information that can be derived from the processed content data.

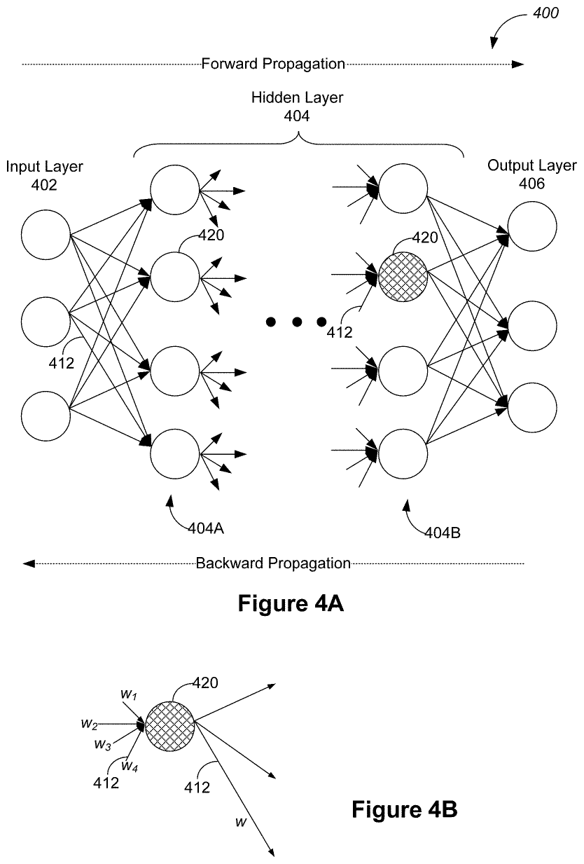

FIG. 4A is an example neural network (NN) 400 applied to process content data in an NN-based data processing model 240, in accordance with some embodiments, and FIG. 4B is an example node 420 in the neural network (NN) 400, in accordance with some embodiments. The data processing model 240 is established based on the neural network 400. A corresponding model-based processing module 316 applies the data processing model 240 including the neural network 400 to process content data that has been converted to a predefined content format. The neural network 400 includes a collection of nodes 420 that are connected by links 412. Each node 420 receives one or more node inputs and applies a propagation function to generate a node output from the one or more node inputs. As the node output is provided via one or more links 412 to one or more other nodes 420, a weight w associated with each link 412 is applied to the node output. Likewise, the one or more node inputs are combined based on corresponding weights w₁, w₂, w₃, and w₄ according to the propagation function. In an example, the propagation function is a product of a non-linear activation function and a linear weighted combination of the one or more node inputs.

The collection of nodes 420 is organized into one or more layers in the neural network 400. Optionally, the one or more layers includes a single layer acting as both an input layer and an output layer. Optionally, the one or more layers includes an input layer 402 for receiving inputs, an output layer 406 for providing outputs, and zero or more hidden layers 404 (e.g., 404A and 404B) between the input and output layers 402 and 406. A deep neural network has more than one hidden layers 404 between the input and output layers 402 and 406. In the neural network 400, each layer is only connected with its immediately preceding and/or immediately following layer. In some embodiments, a layer 402 or 404B is a fully connected layer because each node 420 in the layer 402 or 404B is connected to every node 420 in its immediately following layer. In some embodiments, one of the one or more hidden layers 404 includes two or more nodes that are connected to the same node in its immediately following layer for down sampling or pooling the nodes 420 between these two layers. Particularly, max pooling uses a maximum value of the two or more nodes in the layer 404B for generating the node of the immediately following layer 406 connected to the two or more nodes.

In some embodiments, a convolutional neural network (CNN) is applied in a data processing model 240 to process content data (particularly, video and image data). The CNN employs convolution operations and belongs to a class of deep neural networks 400, i.e., a feedforward neural network that only moves data forward from the input layer 402 through the hidden layers to the output layer 406. The one or more hidden layers of the CNN are convolutional layers convolving with a multiplication or dot product. Each node in a convolutional layer receives inputs from a receptive area associated with a previous layer (e.g., five nodes), and the receptive area is smaller than the entire previous layer and may vary based on a location of the convolution layer in the convolutional neural network. Video or image data is pre-processed to a predefined video/image format corresponding to the inputs of the CNN. The pre-processed video or image data is abstracted by each layer of the CNN to a respective feature map. By these means, video and image data can be processed by the CNN for video and image recognition, classification, analysis, imprinting, or synthesis.

Alternatively and additionally, in some embodiments, a recurrent neural network (RNN) is applied in the data processing model 240 to process content data (particularly, textual and audio data). Nodes in successive layers of the RNN follow a temporal sequence, such that the RNN exhibits a temporal dynamic behavior. In an example, each node 420 of the RNN has a time-varying real-valued activation. Examples of the RNN include, but are not limited to, a long short-term memory (LSTM) network, a fully recurrent network, an Elman network, a Jordan network, a Hopfield network, a bidirectional associative memory (BAM network), an echo state network, an independently RNN (IndRNN), a recursive neural network, and a neural history compressor. In some embodiments, the RNN can be used for handwriting or speech recognition. It is noted that in some embodiments, two or more types of content data are processed by the data processing module 228, and two or more types of neural networks (e.g., both CNN and RNN) are applied to process the content data jointly.

The training process is a process for calibrating all of the weights wᵢ for each layer of the learning model using a training data set which is provided in the input layer 402. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured, and the weights are adjusted accordingly to decrease the error. The activation function is optionally linear, rectified linear unit, sigmoid, hyperbolic tangent, or of other types. In some embodiments, a network bias term b is added to the sum of the weighted outputs from the previous layer before the activation function is applied. The network bias b provides a perturbation that helps the NN 400 avoid over fitting the training data. The result of the training includes the network bias parameter b for each layer.

Image Fusion is to combine information from different image sources into a compact form of image that contains more information than any single source image. In some embodiments, image fusion is based on different sensory modalities of the same camera or two distinct cameras, and the different sensory modalities contain different types of information, including color, brightness, and detail information. For example, color images (RGB) are fused with NIR images, e.g., using deep learning techniques, to incorporate details of the NIR images into the color images while preserving the color and brightness information of the color images. A fused image incorporates more details from a corresponding NIR image and has a similar RGB look to a corresponding color image. Various embodiments of this application can achieve a high dynamic range (HDR) in a radiance domain, optimize amount of details incorporated from the NIR images, prevent a see-through effect, preserve color of the color images, and dehaze the color or fused images. As such, these embodiments can be widely used for different applications including, but not limited to, autonomous driving and visual surveillance applications.

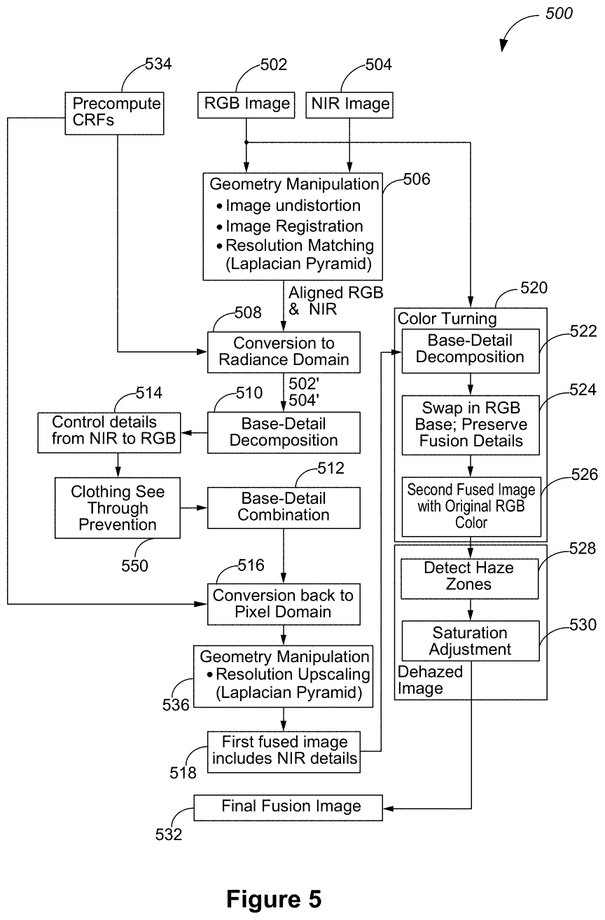

FIG. 5 is an example framework 500 of fusing an RGB image 502 and an NIR image 504, in accordance with some embodiments. The RGB image 502 and NIR image 504 are captured simultaneously in a scene by a camera or two distinct cameras (specifically, by an NIR image sensor and a visible light image sensor of the same camera or two distinct cameras). One or more geometric characteristics of the NIR image and the RGB image are manipulated (506), e.g., to reduce a distortion level of at least a portion of the RGB and NIR images 502 and 504, to transform the RGB and NIR image 502 and 504 into the same coordinate system associated with the scene. In some embodiments, a field of the view of the NIR image sensor is substantially identical to that of the visible light image sensor. Alternatively, in some embodiments, the fields of view of the NIR and visible light image sensors are different, and at least one of the NIR and RGB images is cropped to match the fields of view. Matching resolution are desirable, but not necessary. In some embodiments, the resolution of at least one of the RGB and NIR images 502 and 504 is adjusted to match their resolutions, e.g., using a Laplacian pyramid.

The normalized RGB image 502 and NIR image 504 are converted (508) to a RGB image 502′ and a first NIR image 504′ in a radiance domain, respectively. In the radiance domain, the first NIR image 504′ is decomposed (510) to an NIR base portion and an NIR detail portion, and the first RGB image 502′ is decomposed (510) to an RGB base portion and an RGB detail portion. In an example, a guided image filter is applied to decompose the first RGB image 502′ and/or the first NIR image 504′. A weighted combination 512 of the NIR base portion, RGB base portion, NIR detail portion and RGB detail portion is generated using a set of weights. Each weight is manipulated to control how much of a respective portion is incorporated into the combination. Particularly, a weight corresponding to the NIR base portion is controlled (514) to determine how much of detail information of the first NIR image 514′ is utilized. The weighted combination 512 in the radiance domain is converted (516) to a first fused image 518 in an image domain (also called “pixel domain”). This first fused image 518 is optionally upscaled to a higher resolution of the RGB and NIR images 502 and 504 using a Laplacian pyramid. By these means, the first fused image 518 maintains original color information of the RGB image 502 while incorporating details from the NIR image 504.

In some embodiments, the set of weights used to obtain the weighted combination 512 includes a first weight, a second weight, a third weight and a fourth weight corresponding to the NIR base portion, NIR detail portion, RGB base portion and RGB detail portion, respectively. The second weight corresponding to the NIR detail portion is greater than the fourth weight corresponding to the RGB detail portion, thereby allowing more details of the NIR image 504 to be incorporated into the RGB image 502. Further, in some embodiments, the first weight corresponding to the NIR base portion is less than the third weight corresponding to the RGB base portion. Additionally, in some embodiments not shown in FIG. 5, the first NIR image 504′ includes an NIR luminance component, and the first RGB image 502′ includes an RGB luminance component. An infrared emission strength is determined based on the NIR and RGB luminance components. At least one of the set of weights is generated based on the infrared emission strength, such that the NIR and RGB luminance components are combined based on the infrared emission strength.

In some embodiments, a Camera Response Function (CRF) is computed (534) for the camera(s). The CRF optionally includes separate CRF representations for the RGB image sensor and the NIR image sensor. The CRF representations are applied to convert the RGB and NIR images 502 and 504 to the radiance domain and convert the weighted combination 512 back to the image domain after image fusion. Specifically, the normalized RGB and NIR images are converted to the first RGB and NIR images 502′ and 504′ in accordance with the CRF of the camera, and the weighted combination 512 is converted to the first fused image 518 in accordance with the CRF of the camera(s).

In some embodiments, before the first RGB and NIR images 502′ and 504′ are decomposed, their radiance levels are normalized. Specifically, it is determined that the first RGB image 502′ has a first radiance covering a first dynamic range and that the first NIR image 504′ has a second radiance covering a second dynamic range. In accordance with a determination that the first dynamic range is greater than the second dynamic range, the first NIR image 504′ is modified, i.e., the second radiance of the first NIR image 504′ is mapped to the first dynamic range. Conversely, in accordance with a determination that the first dynamic range is less than the second dynamic range, the first RGB image 502′ is modified, i.e., the first radiance of the first RGB image 502′ is mapped to the second dynamic range.

In some embodiments, a weight in the set of weights (e.g., the weight of the NIR detail portion) corresponds to a respective weight map configured to control different regions separately. The NIR image 504 includes a portion having details that need to be hidden, and the weight corresponding to the NIR detail portion includes one or more weight factors corresponding to the portion of the NIR detail portion. An image depth of the region of the first NIR image is determined. The one or more weight factors are determined based on the image depth of the region of the first NIR image. The one or more weight factors corresponding to the region of the first NIR image are less than a remainder of the second weight corresponding to a remaining portion of the NIR detail portion. As such, the region of the first NIR image is protected (550) from a see-through effect that could potentially cause a privacy concern in the first fusion image.

Under some circumstances, the first fused image 518 is processed using a post processing color tuning module 520 to tune its color. The original RGB image 502 is fed into the color tuning module 520 as a reference image. Specifically, the first fused image 518 is decomposed (522) into a fused base portion and a fused detail portion, and the RGB image 502 is decomposed (522) into a second RGB base portion and a second RGB detail portion. The fusion base portion of the first fused image 518 is swapped (524) with the second RGB base portion. Stated another way, the fused detail portion is preserved (524) and combined with the second RGB base portion to generate a second fused image 526. In some embodiments, color of the first fused image 518 deviates from original color of the RGB image 502 and looks unnatural or plainly wrong, and a combination of the fused detail portion of the first fused image 518 and the second RGB base portion of the RGB image 502 (i.e., the second fused image 526) can effectively correct color of the first fused image 518.

Alternatively, in some embodiments not shown in FIG. 5, color of the first fused image 518 is corrected based on a plurality of color channels in a color space. A first color channel (e.g., a blue channel) is selected from the plurality of color channels as an anchor channel. An anchor ratio is determined between a first color information item and a second color information item that correspond to the first color channel of the first RGB 502′ and the first fused image 518, respectively. For each of one or more second color channels (e.g., a red channel, a green channel) distinct from the first color channel, a respective corrected color information item is determined based on the anchor ratio and at least a respective third information item corresponding to the respective second color channel of the first RGB image 502′. The second color information item of the first color channel of the first fused image and the respective corrected color information item of each of the one or more second color channels to generate a third fused image.

In some embodiments, the first fused image 518 or second fused image 526 is processed (528) to dehaze the scene to see through fog and haze. For example, one or more hazy zones are identified in the first fused image 518 or second fused image 526. A predefined portion of pixels (e.g., 0.1%, 5%) having minimum pixel values are identified in each of the one or more hazy zones, and locally saturated to a low-end pixel value limit. Such a locally saturated image is blended with the first fused image 518 or second fused image 526 to form a final fusion image 532 which is properly dehazed while having enhanced NIR details with original RGB color. A saturation level of the final fusion image 532 is optionally adjusted (530) after the haze is removed locally (528). Conversely, in some embodiments, the RGB image 502 is pre-processed to dehaze the scene to see through fog and haze prior to being converted (508) to the radiance domain or decomposed (510) to the RGB detail and base portions. Specifically, one or more hazy zones are identified in the RGB image 502 that may or may not have been geometrically manipulated. A predefined portion of pixels (e.g., 0.1%, 5%) having minimum pixel values are identified in each of the one or more hazy zones of the RGB image 502, and locally saturated to a low-end pixel value limit. The locally saturated RGB image is geometrically manipulated (506) and/or converted (508) to the radiance domain.

In some embodiments, the framework 500 is implemented at an electronic device (e.g., 200 in FIG. 2) in accordance with a determination that the electronic device operates in a high dynamic range (HDR) mode. Each of the first fused image 518, second fused image 526, and final fusion image 532 has a greater HDR than the RGB image 502 and NIR image 504. The set of weights used to combine the base and detail portions of the RGB and NIR images are determined to increase the HDRs of the RGB and NIR images. In some situations, the set of weights corresponds to optimal weights that result in a maximum HDR for the first fused image. However, in some embodiments, it is difficult to determine the optimal weights, e.g., when one of the RGB and NIR images 502 and 504 is dark while the other one of the RGB and NIR images 502 and 504 is bright due to their differences in imaging sensors, lens, filters, and/or camera settings (e.g., exposure time, gain). Such a brightness difference is sometimes observed in the RGB & NIR images 502 and 504 that are taken in a synchronous manner by image sensors of the same camera. In this application, two images are captured in a synchronously manner when the two images are captured concurrently or within a predefined duration of time (e.g., within 2 seconds, within 5 minutes), subject to the same user control action (e.g., a shutter click) or two different user control actions.

It is noted that each of the RGB and NIR images 502 and 504 can be in a raw image format or any other image format. Broadly speaking, in some embodiments, the framework 500 applies to two images that are not limited to the RGB and NIR images 502 and 504. For example, a first image and a second image are captured for a scene by two different sensor modalities of a camera or two distinct cameras in a synchronous manner. After one or more geometric characteristics are normalized for the first image and the second image, the normalized first image and the normalized second image are converted to a third image and a fourth image in a radiance domain, respectively. The third image is decomposed to a first base portion and a first detail portion, and the fourth image is decomposed to a second base portion and a second detail portion. A weighted combination of the first base portion, first base portion, second detail portion and second detail portion using a set of weights. The weighted combination in the radiance domain is converted to a first fused image in an image domain. Likewise, in different embodiments, image registration, resolution matching, and color tuning may be applied to the first and second images.

Image alignment or image registration is applied to transform different images into a common coordinate system, when these images are taken at different vantage points of the same scene with some common visual coverage of the scene. When two images that are not properly aligned are fused, ghosting occurs in a resulting image. Conversely, no ghost should be observed in an NIR image that is properly registered and overlaid on top of an RGB image, and such two properly registered images can be further fused to improve a visual appearance of the resulting image. As such, image alignment or registration can enable HDR imaging, panoramic imaging, multi-sensory image fusion, remote sensing, medical imaging, and many other image processing applications, thereby playing an important role in the field of computer vision and image processing.

In some embodiments associated with image alignment, feature points are detected in two images that are captured in a synchronous manner, e.g., using a scale invariant feature transform (SIFT) method. Correlations are established across these two images based on those feature points, and a global geometric transform can be computed with those correlations. In some situations, objects in the scene are relatively far away from the camera, and further objects are pulled closer in a long focal length than a short focal length. The global geometric transform provides a registration accuracy level satisfying a registration tolerance. Alternatively, in some situations, depths of the objects vary, e.g., between 1 centimeter and 100 meters, a local geometric transform is implemented to supplemental the global geometric transform and mitigate slight misalignments caused by a variation of the object depth within the scene. The local geometric transform requires relatively more computation resources than the global geometric transform. As such, the local geometric transform is controlled with selective and scalable refinement resolutions to increase the registration accuracy level at various image depths while reducing a required processing time.

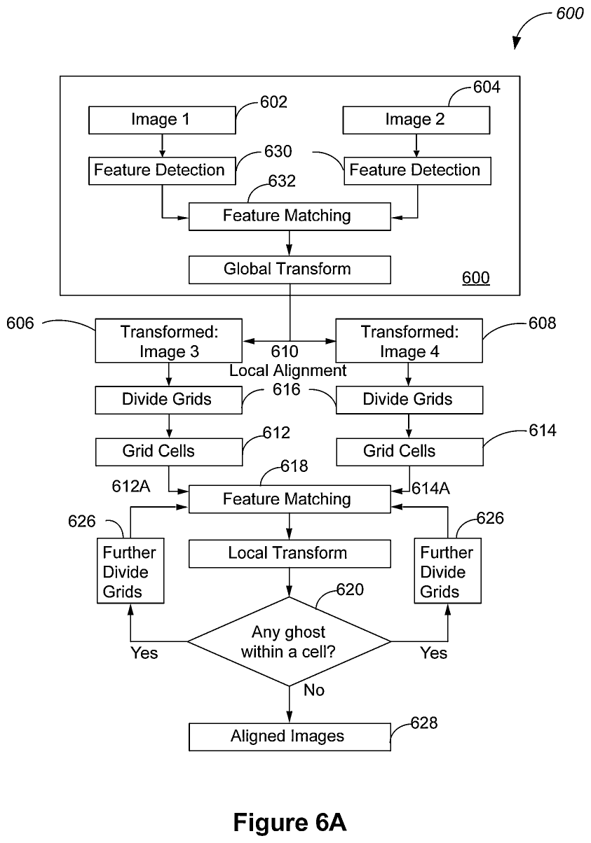

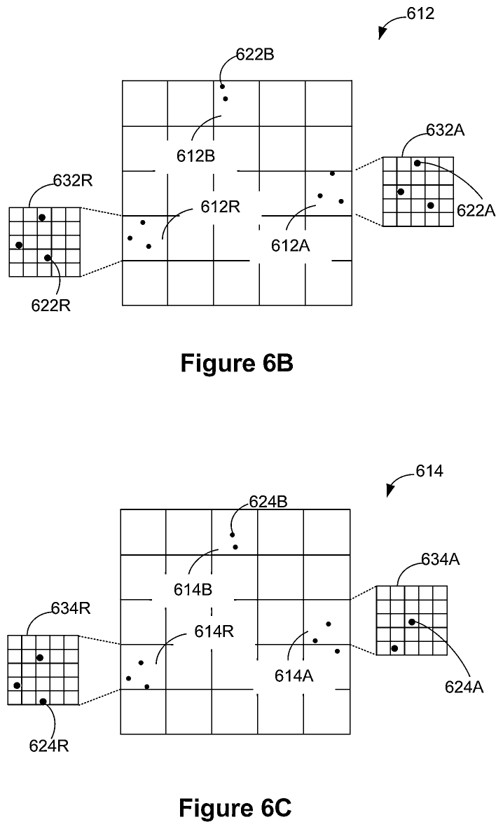

FIG. 6A is an example framework 600 of implementing an image registration process, in accordance with some embodiments, and FIGS. 6B and 6C are two images 602 and 604 that are aligned during the image registration process, in accordance with some embodiments. A first image 602 and a second image 604 are captured simultaneously in a scene (e.g., by different image sensors of the same camera or two distinct cameras). In an example, the first and second images 602 and 604 include an RGB image and an NIR image that are captured by an NIR image sensor and a visible light image sensor of the same camera, respectively. The first and second images 602 and 604 are globally aligned (610) to generate a third image 606 corresponding to the first image 602 and a fourth image 608 corresponding to the second image 604, respectively. The fourth image 608 is aligned with the third image 606. In some embodiments, one or more global feature points are identified (630) in both the first and second images 602 and 604, e.g., using SIFT, oriented FAST, or rotated BRIEF (ORB). At least one of the first and second images 602 and 604 is transformed to align (632) the one or more global feature points in the first and second images 602 and 604. In some embodiments, the third image 606 is identical to the first image 602 and used as a reference image, and the first and second images are globally aligned by transforming the second image 604 to the fourth image 608 with reference to the first image 602.

Each of the third image 606 and the fourth image 608 is divided (616) to a respective plurality of grid cells 612 or 614 including a respective first grid cell 612A or 614A. The respective first grid cell 612A of the third image 606 corresponds to the respective first grid cell 614A of the fourth images 608. In accordance with a feature matching procedure 618, one or more first feature points 622A are identified for the first grid cell 612A of the third image 606, and one or more first feature points 624A are identified for the first grid cell 614A of the fourth images 608. Relative positions of the one or more first feature points 624A in the first grid cell 614A of the fourth image 608 are shifted compared with relative positions of the one or more first feature points 622A in the grid cell 612A of the third image 606. In this example, the first grid cell 612A of the third image 606 has three feature points 622A. Due to a position shift of the fourth image, the first grid cell 614A of the fourth image 608 has two feature points 624A, and another feature point has moved to a grid cell below the first grid cell 614A of the fourth image 608.

The first feature point(s) 622A of the third image 606 is compared with the first feature point(s) 624A of the fourth image 608 to determine (620) a grid ghosting level of the first grid cells 612A and 614A. In some embodiments, the grid ghosting level of the first grid cells 612A and 614A is determined based on the one or more first feature points 622A and 624A, and compared with a grid ghosting threshold V_{GTH}. In accordance with a determination that the grid ghosting level of the first grid cells 612A and 614A is greater than the grid ghosting threshold V_{GTH}, each of the first grid cells 612A and 614A is divided (626) to a set of sub-cells 632A or 634A and the one or more first feature points 622A or 624A are updated in the set of sub-cells 632A or 634A, respectively. The third and fourth images 606 and 608 are further aligned (628) based on the one or more updated first feature points 622A or 624A of the respective first grid cell 612A or 614A.

It is noted that in some embodiments, a range of an image depth is determined for the first and second images 602 and 604 and compared with a threshold range to determine whether the range of the image depth exceeds the threshold range. Each of the third and fourth images 606 and 608 is divided to the plurality of grid cells 612 or 614 in accordance with a determination that the range of the image depth exceeds the threshold range.

In some embodiments, after the respective first grid cell 612A or 614A are divided to the set of sub-cells 632A or 634A, one or more additional feature points are identified in the set of sub-cells in addition to the one or more first feature points 622A or 624A. Alternatively, a subset of the one or more first feature points 622A may be removed when the first feature points 622A are updated. As such, the one or more updated first feature points 622A or 624A includes a subset of the one or more first feature points 622A or 624A, one or more additional feature points in the set of the sub-cells 632A or 634A, or a combination thereof. Each of the one or more additional feature points is distinct from any of the one or more first feature points 622A or 624A. It is noted that in some embodiments, the one or more first feature points 622A or 624A includes a subset of the global feature points generated when the first and second images 602 and 604 are globally aligned.

In some embodiments, the first and second images 602 and 604 are aligned globally based on a transformation function, and the transformation function is updated based on the one or more updated first feature points 622A or 624A of the respective first grid cell 612A or 614A of each of the third and fourth images 606 and 608. The transformation function is used to convert images between two distinct coordinate systems. The third and fourth images 606 and 608 are further aligned based on the updated transformation function.

Referring to FIGS. 6B and 6C, in some embodiments, the plurality of grid cells 612 of the third image 606 includes remaining grid cells 612R distinct from and complimentary to the first grid cell 612A in the third image 606. The plurality of grid cells 614 of the fourth image 608 includes remaining grid cells 614R distinct from and complimentary to the first grid cell 614A in the fourth image 608. The remaining grid cells 612R and 614R are scanned. Specifically, one or more remaining feature points 622R are identified in each of a subset of remaining grid cell 612R of the third image 606, and one or more remaining feature points 624R are identified in a corresponding remaining grid cell 614R of the fourth image 608. Relative positions of the one or more remaining feature points 624R in a remaining grid cell 614R of the fourth image 608 are optionally shifted compared with relative positions of one or more remaining feature points 622R in a remaining grid cell 612R of the third image 606. In accordance with a determination that a grid ghosting level of the respective remaining grid cell 612R or 614R is greater than the grid ghosting threshold V_{GTH}, the respective remaining grid cell 612R or 614R is iteratively divided to a set of remaining sub-cells 632R or 634R to update the one or more remaining feature points 622R or 624R in the set of remaining sub-cells 632R or 634R, respectively, until a sub-cell ghosting level of each remaining sub-cell 632R or 634R is less than a respective sub-cell ghosting threshold. Optionally, a first subset of the remaining sub-cells 632R or 634R is not divided any more. Optionally, each of a subset of the remaining sub-cells 632R or 634R is further divided once, twice, or more than twice. In some embodiments, at least one pair of the remaining grid cells 612R and 614R are not divided to sub-cells in accordance with a determination that their grid ghosting level is less than the grid ghosting threshold V_{GTH}.

In some embodiments, the plurality of grid cells 612 of the third image 606 includes a second grid cell 612B distinct from the first grid cell 612A, and the plurality of grid cells 614 of the fourth image 608 includes a second grid cell 614B that is distinct from the first grid cell 614A and corresponds to the second grid cell 612B of the third image 606. One or more second feature points 622B are identified in the second grid cell 612B of the third image 606, and one or more second feature points 624B are identified in the second grid cell 614B of the fourth image 608. Relative positions of the one or more second feature points 624B in the second grid cell 614B of the fourth image 608 are optionally shifted compared with relative positions of the one or more second feature points 622B in the second grid cell 612B of the third image 606. It is determined that a grid ghosting level of the respective second grid cell 612B or 614B is less than the grid ghosting threshold V_{GTH}. The third and fourth images 606 and 608 are further aligned based on the one or more second feature points of the respective second grid cell of each of the third and fourth images. That said, the second grid cells 612B and 614B do not need to be divided to a set of sub-cells to update the one or more second feature points 622B and 624B because the one or more second feature points 622B and 624B have been accurately identified to suppress the grid ghosting level of the respective second grid cell 612B or 614B.

Stated another way, in some embodiments, a first image 602 and a second image 604 of a scene are obtained and aligned globally to generate a third image 606 corresponding to the first image and a fourth image 608 corresponding to the second image 604 and aligned with the third image 606. Each of the third image 606 and a fourth image 608 to a respective plurality of grid cells 612 or 614. For each of a subset of grid cell 612 or 614 of the third and fourth images 606 and 608, one or more local feature points 622 or 624 are identified in the respective grid cell 612 or 614 of the third image 606 or fourth images 608, respectively. In accordance with a determination that a grid ghosting level of the respective grid cell is greater than a grid ghosting threshold VGTH, the respective grid cell 612 or 614 is iteratively divided to a set of sub-cells 632 or 634 to update the one or more local feature points 622 or 624 in the set of sub-cells 632 or 634, until a sub-cell ghosting level of each sub-cell 632 or 634 is less than a respective sub-cell ghosting threshold. The third and fourth images 606 and 608 are further aligned based on the one or more updated local feature points 622 or 624 of the grid cells 612 or 614 of the third and fourth images 606 and 608. Optionally, at least one pair of the grid cells 612 and 614 are not divided to sub-cells in accordance with a determination that their grid ghosting level is less than the grid ghosting threshold V_{GTH} (i.e., each of the at least one pair of the grid cells 612 and 614 fully overlaps with negligible ghosting). Optionally, each of a subset of the grid cells 612 and 614 is divided to sub-cells for once, twice, or more than twice.

Cell dividing and feature point updating are implemented iteratively. That said, once a ghost is detected within a grid cell or sub-cell, the grid cell or sub-cell is divided into smaller sub-cells. The feature points 622 or 624 that are detected in the grid cell or sub-cell having the ghost can be reused for the smaller sub-cells. The smaller sub-cells within the grid cell or sub-cell having the ghost are filled in with feature points. This process is repeated until no ghost is detected within any of the smaller sub-cells. As such, the framework 600 provides accurate alignment of the first and second images 602 and 604 at a fast processing time.

Referring to FIG. 6A, it is best to start off with larger grid cells, and then further divide the grid cells when the objects within those cells are determined not being aligned well. The grid cells are selectively divided, which controls the computation time while iteratively improving alignment of those grid cells that are initially misaligned. A normalized cross-correlation (NCC) or any ghost detection algorithm can be applied to determine whether objects are aligned in each grid cell (e.g., determine whether the grid ghosting level is greater than the grid ghosting threshold V_{GTH}). For local grid-level alignment, a portion of the processing time Tₘ is spent on finding the corresponding features points in the images 606 and 608. Given an image resolution of W×H, where W and H are width and height of the image, a maximum matching time will be W×H×Tₘ. When the image is divided into m×n grid cells, each run takes at most W×H/(m×n) faster than the worst case. For example, for an image size of 4000×3000 pixels and a grid size of 50×50, a processing speed is 4800 times faster than algorithms that perform pixel-by-pixel matching for the entire image.

In some embodiments, the third and fourth images 606 and 608 are divided such that each grid cell 612 or 614 is used as a matching template having a corresponding feature point 622 or 624 defined at a center of the respective grid cell 612 or 614. The matching templates of the grid cells 612 of the third image 606 are compared and matched to the matching templates of the grid cells 614 of the fourth image 608. Optionally, the fourth image 608 acts as a reference image, and each grid cell 614 of the fourth image 608 is associated with a corresponding grid cell 612 of the third image 606. For each grid cell 614 in the fourth image 608, the grid cells 612 of the third image 606 are scanned according to a search path to identify the corresponding grid cell 612 of the third image 606. In example, the third and fourth images 606 and 608 are rectified, and the search path follows an epipolar line. Similarly and optionally, the third image 606 acts as a reference image, and each grid cell 612 of the third image 606 is associated with a corresponding grid cell 614 of the fourth image 608, e.g., by scanning the grid cells 614 of the fourth image 608 according to an epipolar line. By these means, the total number of the feature points detected for the third and fourth images 606 or 608 can be increased, e.g., doubled in some situations.

It is noted that a ghost between two corresponding grid cells or sub-cells of the third and fourth images 606 and 608 is detected, but not replaced with other pixel values to remove the ghost from the scene. Rather, to preserve the image details and the image realism, ghost detection is applied to determine whether the grid cells or sub-cells need to be divided further so that a grid cell or sub-cell contains a surface covering approximately the same image depth. In some embodiments, feature points 622 or 624 enclosed within a grid cell or sib-cell are assigned to the grid cell or sub-cell and used in a data term. The data term is used with a similarity transformation term to solve for new vertices to which the grid cell or sub-cell is locally transformed.

After the first and second images 602 and 604 are aligned, the first and second images 602 and 604 may be fused. For example, referring to FIG. 6A, the first and second images 602 and 604 are converted to a radiance domain, and decomposed to a first base portion, a first detail portion, a second base portion, and a second detail portion. The first base portion, first detail portion, second base portion, and second detail portion are combined using a set of weights. A weighted combination is converted from the radiance domain to a fused image in an image domain. A subset of the weights is optionally increased to preserve details of the first image 602 or second image 604. Alternatively, in some embodiments, referring to FIG. 6A, radiances of the first and second images 602 and 604 are matched and combined to generate a fused radiance image, which is further converted to a fused image in the image domain. The fused radiance image optionally includes grayscale or luminance information of the first and second images 602 and 604, and is combined with color information of the first image 602 or second image 604 to obtain the fused image in the image domain. Alternatively, in some embodiments, an infrared emission strength is determined based on luminance components of the first and second images 602 and 604. The luminance components of the first and second images 602 and 604 are combined based on the infrared emission strength. Such a combined luminance component is further merged with color components of the first image 602 to obtain a fused image.

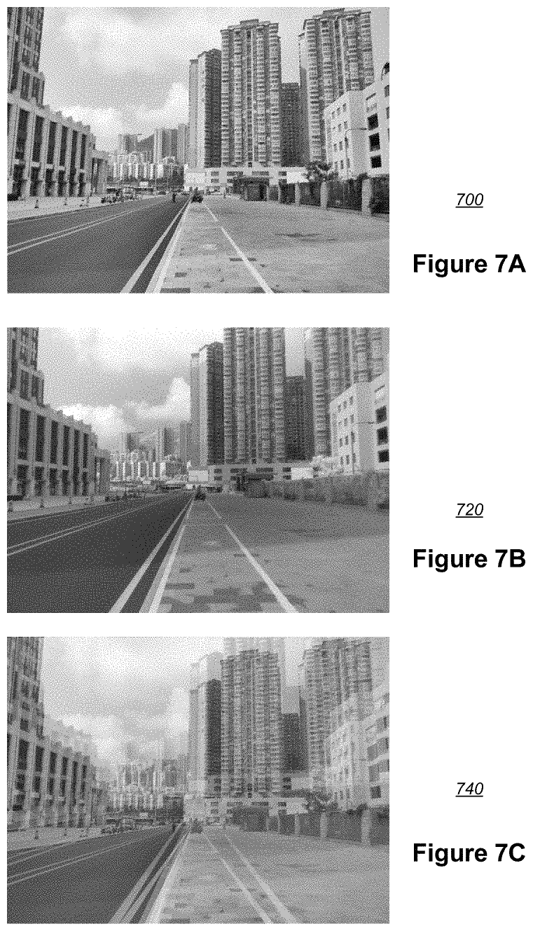

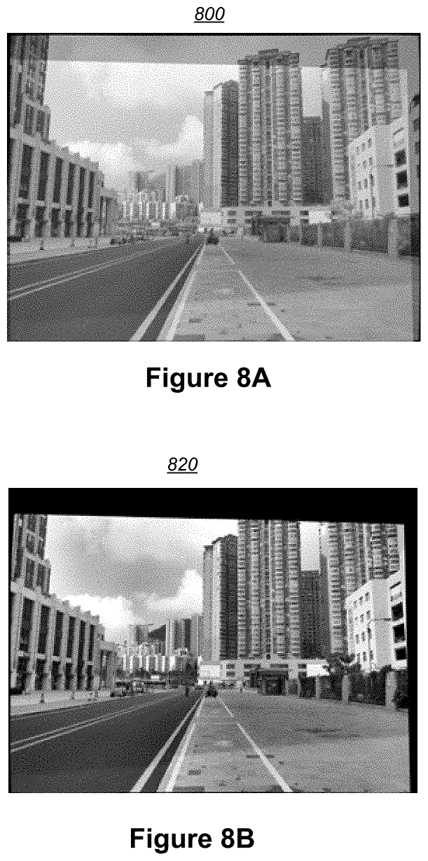

FIGS. 7A-7C are an example RGB image 700, an example NIR image 720, and an improperly registered image 740 of the images 700 and 720 in accordance with some embodiments, respectively. FIGS. 8A and 8B are an overlaid image 800 and a fused image 820, in accordance with some embodiments, respectively. When the RGB and NIR images 700 and 720 are not aligned properly but fused together, ghosting occurs in the improperly registered image 740. Specifically, ghosting is observed for buildings in the image 740, and lines marked on the streets do not overlap for the RGB and NIR images 700 and 720. After the RGB and NIR images 700 and 720 are aligned and registered, the RGB and NIR images 700 and 720 are overlaid on top of each other to obtain the overlaid image 800. Ghosting has been eliminated as at least one of the RGB and NIR images 700 and 720 is shifted and/or rotated to match with the other one of the RGB and NIR images 700 and 720. Referring to FIG. 8B, image quality of the fused image 820 is further enhanced compared with the overlaid image 800 when some fusion algorithms are applied.

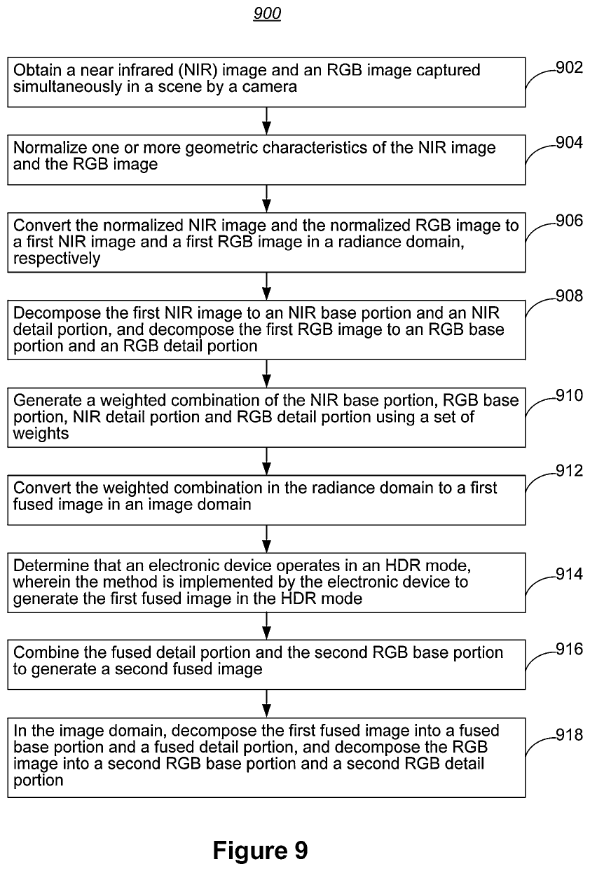

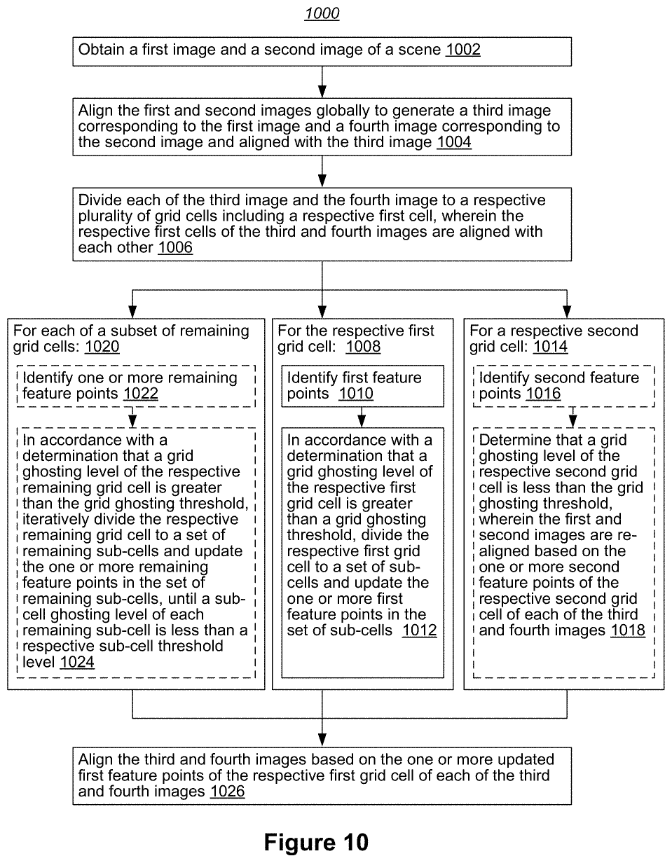

FIGS. 9 and 10 are flow diagrams of image processing methods 900 and 1000 implemented at a computer system, in accordance with some embodiments. Each of the methods 900 and 1000 is, optionally, governed by instructions that are stored in a non-transitory computer readable storage medium and that are executed by one or more processors of the computer system (e.g., a server 102, a client device 104, or a combination thereof). Each of the operations shown in FIGS. 9 and 10 may correspond to instructions stored in the computer memory or computer readable storage medium (e.g., memory 206 in FIG. 2) of the computer system 200. The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. Some operations in the methods 900 and 1000 may be combined and/or the order of some operations may be changed. More specifically, each of the methods 900 and 1000 is governed by instructions stored in an image processing module 250, a data processing module 228, or both in FIG. 2.

FIG. 9 is a flow diagram of an image fusion method 900 implemented at a computer system 200 (e.g., a server 102, a client device, or a combination thereof), in accordance with some embodiments. Referring to both FIGS. 5 and 9, the computer system 200 obtains (902) an NIR image 504 and an RGB image 502 captured simultaneously in a scene (e.g., by different image sensors of the same camera or two distinct cameras), and normalizes (904) one or more geometric characteristics of the NIR image 504 and the RGB image 502. The normalized NIR image and the normalized RGB image are converted (906) to a first NIR image 504′ and a first RGB image 502′ in a radiance domain, respectively. The first NIR image 504′ is decomposed (908) to an NIR base portion and an NIR detail portion, and the first RGB image 502′ is decomposed (908) to an RGB base portion and an RGB detail portion. The computer system generates (910) a weighted combination 512 of the NIR base portion, RGB base portion, NIR detail portion and RGB detail portion using a set of weights, and converts (912) the weighted combination 512 in the radiance domain to a first fused image 518 in an image domain. In some embodiments, the NIR image 504 has a first resolution, and the RGB image 502 has a second resolution. The first fused image 518 is upscaled to a larger resolution of the first and second solutions using a Laplacian pyramid.

In some embodiments, the computer system determines a CRF for the camera. The normalized NIR and RGB images are converted to the first NIR and RGB images 504′ and 502′ in accordance with the CRF of the camera. The weighted combination 512 is converted to the first fused image 518 in accordance with the CRF of the camera. In some embodiments, the computer system determines (914) that it operates in a high dynamic range (HDR) mode. The method 900 is implemented by the computer system to generate the first fused image 518 in the HDR mode.

In some embodiments, the one or more geometric characteristics of the NIR image 504 and the RGB image 502 are manipulated by reducing a distortion level of at least a portion of the RGB and NIR images 502 and 504, implementing an image registration process to transform the NIR image 504 and the RGB image 502 into a coordinate system associated with the scene, or matching resolutions of the NIR image 504 and the RGB image 502.

In some embodiments, prior to decomposing the first NIR image 504′ and decomposing the first RGB image 502′, the computer system determines that the first RGB image 502′ has a first radiance covering a first dynamic range and that the first NIR image 504′ has a second radiance covering a second dynamic range. In accordance with a determination that the first dynamic range is greater than the second dynamic range, the computer system modifies the first NIR image 504′ by mapping the second radiance of the first NIR image 504′ to the first dynamic range. In accordance with a determination that the first dynamic range is less than the second dynamic range, the computer system modifies the first RGB image 502′ by mapping the first radiance of the first RGB image 502′ to the second dynamic range.

In some embodiments, the set of weights includes a first weight, a second weight, a third weight and a fourth weight corresponding to the NIR base portion, NIR detail portion, RGB base portion and RGB detail portion, respectively. The second weight is greater than the fourth weight. Further, in some embodiments, the first NIR image 504′ includes a region having details that need to be hidden, and the second weight corresponding to the NIR detail portion includes one or more weight factors corresponding to the region of the NIR detail portion. The computer system determines an image depth of the region of the first NIR image 504′ and determines the one or more weight factors based on the image depth of the region of the first NIR image 504′. The one or more weight factors corresponding to the region of the first NIR image are less than a remainder of the second weight corresponding to a remaining portion of the NIR detail portion.

In some embodiments, the computer system tune color characteristics of the first fused image in the image domain. The color characteristics of the first fused image include at least one of color intensities and a saturation level of the first fused image 518. In some embodiments, in the image domain, the first fused image 518 is decomposed (916) into a fused base portion and a fused detail portion, and the RGB image 502 is decomposed (918) into a second RGB base portion and a second RGB detail portion. The fused detail portion and the second RGB base portion are combined (916) to generate a second fused image. In some embodiments, one or more hazy zones are identified in the first fused image 518 or the second fused image, such that white balance of the one or more hazy zones is adjusted locally. Specifically, in some situations, the computer system detects one or more hazy zones in the first fused image 518, and identifies a predefined portion of pixels having minimum pixel values in each of the one or more hazy zones. The first fused image 518 is modified to a first image by locally saturating the predefined portion of pixels in each of the one or more hazy zones to a low-end pixel value limit. The first fused image 518 and the first image are blended to form a final fusion image 532. Alternatively, in some embodiments, one or more hazy zones are identified in the RGB image 502, such that white balance of the one or more hazy zones is adjusted locally by saturating a predefined portion of pixels in each hazy zone to the low-end pixel value limit.

FIG. 10 is a flow diagram of an image registration method 1000 implemented at a computer system 200 (e.g., a server 102, a client device, or a combination thereof), in accordance with some embodiments. Referring to FIGS. 6A-6C and 10, the computer system 200 obtains (1002) a first image 602 and a second image 604 of a scene. In some embodiments, the first image 602 is an RGB image, and the second image 1006 is an NIR image that captured simultaneously with the RGB image (e.g., by different image sensors of the same camera or two distinct cameras). The first and second images 602 and 604 are globally aligned (1004) to generate a third image 606 corresponding to the first image 602 and a fourth image 608 corresponding to the second image 604 and aligned with the third image 606. Each of the third image 606 and the fourth image 608 is divided (1006) to a respective plurality of grid cells 612 or 614 including a respective first grid cell 612A or 614A. The respective first grid cells 612A and 614A of the third and fourth images 606 and 608 are aligned with each other. For the respective first grid cell 612A or 614A of each of the third and fourth images 606 and 608 (1008), one or more first feature points 622A or 624A are identified (1010). In accordance with a determination that a grid ghosting level of the respective first grid cell 612A or 614A is greater than a grid ghosting threshold V_{GTH}, the respective first grid cell 612A or 614A is further divided (1012) to a set of sub-cells 632A or 634A and the one or more first feature points 622A or 624A are updated in the set of sub-cells 632A or 634A. The computer system 200 further aligns (1026) the third and fourth images 606 and 608 based on the one or more updated first feature points 622A or 624A of the respective first grid cell 612A or 614A of each of the third and fourth images 606 and 608.

In some embodiments, the plurality of grid cells 612 or 614 include (1014) a respective second gird cell 612B or 614B in the third image 606 or fourth image 608, respectively. The respective second grid cell 612B or 614B is distinct from the respective first grid cell 612A or 612A. One or more second feature points 622B or 624B are identified (1016) in the respective second grid cell 612B or 614B. The computer system 200 determines (1018) that a grid ghosting level of the respective second grid cell 612B or 614B is less than the grid ghosting threshold V_{GTH}. The first and second images 602 and 604 are re-aligned (1026) based on the one or more second feature points 622B or 624B of the respective second grid cell 612B or 614B of each of the third and fourth images 606 and 608.

In some embodiments, the plurality of grid cells 612 or 614 include (1020) a respective set of remaining grid cells 612R or 614R in the third image 606 or fourth image 608, respectively. The respective set of remaining grid cells 612R or 614R are distinct from and complimentary to the respective first grid cell 612A or 612A. The set of remaining grid cells 612R or 614R is scanned. For each of a subset of remaining grid cells 612R or 614R in the third and fourth images 606 and 608, the computer system 200 identifies (1022) one or more remaining feature points 622R or 624R. For each of the subset of remaining grid cell 612R or 614R (1020), in accordance with a determination that a grid ghosting level of the respective remaining grid cell is greater than the grid ghosting threshold, the computer system 200 iteratively divides (1024) the respective remaining grid cell 612R or 614 to a set of remaining sub-cells 632R or 634R and updates the one or more remaining feature points 622R and 624R in the set of remaining sub-cells 632R or 634R, until a sub-cell ghosting level of each remaining sub-cell 632R or 634R is less than a respective sub-cell ghosting threshold.

In some embodiments, the first and second images 602 and 604 are aligned globally based on a transformation function. The transformation function is updated based on the one or more updated first feature points 622A or 624A of the respective first grid cell 612A or 614B of each of the third and fourth images 606 and 608. The third and fourth images 606 and 608 are further aligned (1026) based on the updated transformation function.

In some embodiments, the one or more updated first feature points 622A and 624A include a subset of the one or more first feature points 622A and 624A, one or more additional feature points in the set of the sub-cells 632A and 634A, or a combination thereof. Each of the one or more additional feature points is distinct from any of the one or more first feature points 622A and 624A.

In some embodiments, the computer system 200 determines the grid ghosting level of the respective first grid cell 612A or 614A of each of the third and fourth images 606 and 608 based on the one or more first feature points 622A or 624A. The grid ghosting level of the first grid cell 612A or 614A is compared with the grid ghosting threshold V_{GTH}.

In some embodiments, the computer system 200 align (1004) the first and second images 602 and 604 globally by identifying one or more global feature points each of which is included in both the first and second images 602 and 604 and transforming at least one of the first and second images 602 and 604 to align the one or more global feature points in the first and second images 602 and 604. In some embodiments, the third image 606 is identical to the first image 602 and is applied as a reference image, and the first and second images 602 and 604 are aligned (1004) globally by transforming the second image 604 to the fourth image 608 with reference to the first image 602.

In some embodiments, the computer system 200 determines a range of an image depth for the first and second images 602 and 604 and determines whether the range of the image depth exceeds a threshold range. Each of the third and fourth images 606 and 608 is divided to the plurality of grid cells 612 or 614 in accordance with a determination that the range of the image depth exceeds the threshold range.

It should be understood that the particular order in which the operations in each of FIGS. 9 and 10 have been described are merely exemplary and are not intended to indicate that the described order is the only order in which the operations could be performed. One of ordinary skill in the art would recognize various ways to process images as described in this application. Additionally, it should be noted that details described above with respect to FIGS. 5-8 are also applicable in an analogous manner to each of the methods 900 and 1000 described above with respect to FIGS. 9 and 10. For brevity, these details are not repeated for every figure in FIGS. 9 and 10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the embodiments described in the present disclosure. A computer program product may include a computer-readable medium.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, elements, and/or components, but do not preclude the presence or addition of one or more other features, elements, components, and/or groups thereof.

It will also be understood that, although the terms first, second, etc. may be used herein to describe various elements, these elements should not be limited by these terms. These terms are only used to distinguish one element from another. For example, a first electrode could be termed a second electrode, and, similarly, a second electrode could be termed a first electrode, without departing from the scope of the embodiments. The first electrode and the second electrode are both electrodes, but they are not the same electrode.

The description of the present disclosure has been presented for purposes of illustration and description, and is not intended to be exhaustive or limited to the invention in the form disclosed. Many modifications, variations, and alternative embodiments will be apparent to those of ordinary skill in the art having the benefit of the teachings presented in the foregoing descriptions and the associated drawings. The embodiment was chosen and described in order to best explain the principles of the invention, the practical application, and to enable others skilled in the art to understand the invention for various embodiments and to best utilize the underlying principles and various embodiments with various modifications as are suited to the particular use contemplated. Therefore, it is to be understood that the scope of claims is not to be limited to the specific examples of the embodiments disclosed and that modifications and other embodiments are intended to be included within the scope of the appended claims.

What is claimed is:

1. An image registration method, comprising:
obtaining a first image and a second image of a scene;
aligning the first and second images globally to generate a third image corresponding to the first image and a fourth image corresponding to the second image and aligned with the third image;
dividing each of the third image and the fourth image to a respective plurality of grid cells including a respective first grid cell, wherein the respective first grid cells of the third and fourth images are aligned with each other;
for the respective first grid cell of each of the third and fourth images:
identifying one or more first feature points; and
in accordance with a determination that a grid ghosting level of the respective first grid cell is greater than a grid ghosting threshold, dividing the respective first grid cell to a set of sub-cells and updating the one or more first feature points in the set of sub-cells; and
aligning the third and fourth images based on the one or more updated first feature points of the respective first grid cell of each of the third and fourth images.

2. The method of claim 1, further comprising for a respective second grid cell of each of the third and fourth images, the respective second grid cell being distinct from the respective first grid cell:
identifying one or more second feature points; and
determining that a grid ghosting level of the respective second grid cell is less than the grid ghosting threshold, wherein the third and fourth images are further aligned based on the one or more second feature points of the respective second grid cell of each of the third and fourth images.

3. The method of claim 1, wherein the plurality of grid cells include remaining grid cells distinct from the respective first grid cell for each of the third and fourth images, the method further comprising scanning a subset of the remaining grid cells by:
for each of the subset of remaining grid cells in the third and fourth images:
identifying one or more remaining feature points; and
in accordance with a determination that a grid ghosting level of the respective remaining grid cell is greater than the grid ghosting threshold, iteratively dividing the respective remaining grid cell to a set of remaining sub-cells and updating the one or more remaining feature points in the set of remaining sub-cells, until a sub-cell ghosting level of each remaining sub-cell is less than a respective sub-cell ghosting threshold.

4. The method of claim 1, wherein the first and second images are aligned globally based on a transformation function, and aligning the third and fourth images further comprises:
updating the transformation function based on the one or more updated first feature points of the respective first grid cell of each of the third and fourth images, the third and fourth images are further aligned based on the updated transformation function.

5. The method of claim 1, wherein the one or more updated first feature points include a subset of the one or more first feature points, one or more additional feature points in the set of the sub-cells, or a combination thereof, and each of the one or more additional feature points is distinct from any of the one or more first feature points.

6. The method of claim 1, further comprising:
determining the grid ghosting level of the respective first grid cell of each of the third and fourth images based on the one or more first feature points; and
comparing the grid ghosting level of the first grid cell with the grid ghosting threshold.

7. The method of claim 1, wherein aligning the first and second images globally further comprises:
identifying one or more global feature points each of which is included in both the first and second images; and
transforming at least one of the first and second images to align the one or more global feature points in the first and second images.

8. The method of claim 1, wherein the third image is identical to the first image and is applied as a reference image, and aligning the first and second images globally includes transforming the second image to the fourth image with reference to the first image.

9. The method of claim 1, further comprising:
determining a range of an image depth for the first and second images; and
determining whether the range of the image depth exceeds a threshold range, wherein each of the third and fourth images is divided to the plurality of grid cells in accordance with a determination that the range of the image depth exceeds the threshold range.

10. The method of any of claim 1, wherein the method is implemented by an electronic device having a first image sensor and a second image sensor, and the first and second image sensors are configured to capture the first and second images of the scene in a synchronous manner.

11. The method of claim 10, wherein the first image includes an RGB image, the second image includes a near infrared (NIR) image.

12. The method of claim 1, further comprising:
converting the re-aligned first image and the re-aligned second image to a radiance domain;
decomposing the converted first image to a first base portion and a first detail portion, and decomposing the converted second image to a second base portion and a second detail portion;
generating a weighted combination of the first base portion, second base portion, first detail portion and second detail portion using a set of weights; and
converting the weighted combination in the radiance domain to a first fused image in an image domain.

13. The method of claim 1, further comprising:
matching radiances of the re-aligned first and second images;
combining the radiances of the re-aligned first and second images to generate a fused radiance image; and
converting the fused radiance image to a second fused image in an image domain.

14. The method of claim 1, further comprising:
extracting a first luminance component and a first color component from the re-aligned first image;
extracting a second luminance component from the re-aligned second image;
determining an infrared emission strength based on the first and second luminance components;
combining the first and second luminance components based on the infrared emission strength to obtain a combined luminance component; and
combining the combined luminance component with the first color component to obtain a third fused image.

15. A computer system, comprising:
one or more processors; and
memory having instructions stored thereon, which when executed by the one or more processors cause the processors to perform an image registration method, comprising:
obtaining a first image and a second image of a scene;
aligning the first and second images globally to generate a third image corresponding to the first image and a fourth image corresponding to the second image and aligned with the third image;
dividing each of the third image and the fourth image to a respective plurality of grid cells including a respective first grid cell, wherein the respective first grid cells of the third and fourth images are aligned with each other;
for the respective first grid cell of each of the third and fourth images:
identifying one or more first feature points; and
in accordance with a determination that a grid ghosting level of the respective first grid cell is greater than a grid ghosting threshold, dividing the respective first grid cell to a set of sub-cells and updating the one or more first feature points in the set of sub-cells; and
aligning the third and fourth images based on the one or more updated first feature points of the respective first grid cell of each of the third and fourth images.

16. The computer system of claim 15, the method further comprises for a respective second grid cell of each of the third and fourth images, the respective second grid cell being distinct from the respective first grid cell:
identifying one or more second feature points; and
determining that a grid ghosting level of the respective second grid cell is less than the grid ghosting threshold, wherein the third and fourth images are further aligned based on the one or more second feature points of the respective second grid cell of each of the third and fourth images.

17. The computer system of claim 15, wherein the plurality of grid cells include remaining grid cells distinct from the respective first grid cell for each of the third and fourth images, and the method further comprises scanning a subset of the remaining grid cells by:
for each of the subset of remaining grid cells in the third and fourth images:
identifying one or more remaining feature points; and
in accordance with a determination that a grid ghosting level of the respective remaining grid cell is greater than the grid ghosting threshold, iteratively dividing the respective remaining grid cell to a set of remaining sub-cells and updating the one or more remaining feature points in the set of remaining sub-cells, until a sub-cell ghosting level of each remaining sub-cell is less than a respective sub-cell ghosting threshold.

18. The computer system of claim 15, wherein the first and second images are aligned globally based on a transformation function, and aligning the third and fourth images further comprises:
updating the transformation function based on the one or more updated first feature points of the respective first grid cell of each of the third and fourth images, the third and fourth images are further aligned based on the updated transformation function.

19. The computer system of claim 15, wherein the method further comprises:
converting the re-aligned first image and the re-aligned second image to a radiance domain;
decomposing the converted first image to a first base portion and a first detail portion, and decomposing the converted second image to a second base portion and a second detail portion;
generating a weighted combination of the first base portion, second base portion, first detail portion and second detail portion using a set of weights; and
converting the weighted combination in the radiance domain to a first fused image in an image domain.

20. A non-transitory computer-readable medium, having instructions stored thereon, which when executed by one or more processors cause the processors to perform the image registration method of claim 1.
